(19) United States
(12) Patent Application Publication
(10) Pub. No.: US 2006/0228274 A1
(43) Pub. Date: Oct. 12, 2006

(54) Exhaust gas purifying apparatus

(75) Inventor: Kojiro Okada, Nagoya-shi (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha

(21) Appl. No.: 11/398,568

(22) Filed: Apr. 6, 2006

(30) Foreign Application Priority Data
Apr. 8, 2005 (JP) P2005-112795

(51) Int. Cl. B01D 50/00

(52) U.S. Cl. 422/177

(57) ABSTRACT

An exhaust gas purifying apparatus includes a casing provided at an exhaust path of an internal combustion engine, and plural carriers arranged in the casing from an inlet side of an exhaust gas to an outlet side and connected to each other through gap portions. The carrier includes through holes in which the exhaust gas flows and a carrier wall to partition the though holes and to carry a catalyst to purify the exhaust gas. A thickness of a coating layer of a rear catalyst carried by the carrier on the outlet side is set to be larger than a thickness of a coating layer of a front catalyst carried by the carrier on the inlet side. An opening area of the carrier carrying the catalyst on the outlet side is set to be smaller than an opening area of a carrier carrying the catalyst on the inlet side.

### BACKGROUND OF THE INVENTION

1. Field of the Invention

The present invention relates to an exhaust gas purifying apparatus arranged at an exhaust path of an internal combustion engine and having a catalyst for oxidizing or deoxidizing a combustion-produced substance in an exhaust gas exhausted by the internal combustion engine to purify.

2. Description of the Related Art

An exhaust gas purification regulation of an internal combustion engine mounted to a vehicle has been intensified for conservation of environment and in accordance therewith, it has been requested to further promote a purifying efficiency of a catalyst mounted to an exhaust path of an internal combustion engine. In a background art, as a representative catalyst system arranged on an exhaust path of an internal combustion engine, there are a single catalyst system (single carrier) and a tandem catalyst system (two carriers). In the case of the tandem catalyst system, a gap portion is ensured between a forestage catalyst and a poststage catalyst, the system is provided with a characteristic that an exhaust gas reaching the gap portion is diffused in a direction orthogonal to a direction of an exhaust path to be mixed, thereafter, flows to the poststage catalyst and therefore, a catalyst reaction is nondeviatedly produced. Therefore, generally, the tandem catalyst is more excellent than the single catalyst, which is conceived that mixing of the gas produced at the gap portion constitutes one factor of promoting the performance.

However, when a flow path resistance of the poststage catalyst is smaller than that of the forestage catalyst, it is conceivable that a gas flows smoothly from the forestage to the poststage and therefore, an effect of mixing a gas at a gap portion is small and even when the catalyst is formed in tandem, an amount of promoting the performance is small. Hence, according to a catalyst converter disclosed in JP-A-9-195757, there is adopted a method in which catalyst carriers are arranged in three stages by way of gap portions along an exhaust gas flowing direction at inside of a casing thereof, a cell density on a poststage side of each carrier is made to be higher than that of a forestage side to agitate an exhaust gas to increase a probability of bringing the catalyst into contact with the exhaust gas to thereby promote the exhaust gas purifying performance. However, in this case, a low cell density carrier is used at the forestage which effects a significant influence on the exhaust gas purifying performance in view of a total of the forestage and the poststage and exhaust gas purifying performance of a total of the system is deteriorated.

Further, according to JP-A-11-336535, there is disclosed a constitution having displacing means for shifting a relative positional relationship of a partition wall of a forestage and a poststage in order to utilize a total of a catalyst carried by a circular section carrier. However, a catalyst, particularly, a circular section carrier of the catalyst poses a problem that it is inherently difficult to position a carrier in a circumferential direction in canning and a relative positional relationship between a forestage and a poststage cannot arbitrarily rectified at a first time point.

As described above, according to a background art apparatus or the catalyst apparatus of JP-A-9-195757 and JP-A-11-336535, the exhaust gas purifying efficiency is improved by adopting the tandem catalyst system having the forestage catalyst and the post stage catalyst and using the characteristic of agitating the exhaust gas at the gap portion between the forestage catalyst and the poststage catalyst. Meanwhile, in recent years, there are a number of apparatus including multicoating layers of two layers or more of catalysts carried by carriers in order to promote the catalyst performance. According to the kind of apparatus, the catalyst performance can be promoted by preventing alloying by distributing respective noble metal components of Pt, Pd, Rh to the plurality of layers and optimally arranging the noble metals and additive agents to the respective layers. However, as a result, a wash coating is thickened and a heat capacity is increased. Particularly, when a catalyst having a large wash coating capacity is used at the forestage, a temperature rise of the catalyst is retarded, activation of the catalyst is retarded, and the function of purifying a cold exhaust gas is deteriorated. Therefore, when viewed from a viewpoint of early activation of the catalyst in cold starting, it is necessary to take also the heat capacity of the wash coating of the catalyst into consideration.

Further, when the wash coating is thickened by multilayer formation, a performance of diffusing the gas into the wash coating is deteriorated, and exhaust gas is difficult to reach a lower layer. As a result, the noble metal at the essential portion of the catalyst is not used effectively and the expensive noble metal is wasted. Particularly, at the forestage catalyst generally carried with much noble metals for reducing HC in cold starting, also the noble metals are more wasted.

### SUMMARY OF THE INVENTION

The invention has been carried out by paying attention to the above-described problem to provide an exhaust gas purifying apparatus capable of promoting mixing of an exhaust gas at a gap portion, promoting a performance of elevating a temperature of a catalyst in cold starting and achieving to promote a gas diffusing performance of a forestage catalyst layer. In order to achieve the above-described object, according to an aspect of the present embodiment, an exhaust gas purifying apparatus includes a casing provided at an exhaust path of an internal combustion engine, and a plurality of carriers arranged in the casing from an inlet side of an exhaust gas to an outlet side thereof and connected to each other through gap portions. Each of the carriers includes through holes in which the exhaust gas flows and a carrier wall to partition the though holes and to carry a catalyst to purify the exhaust gas. A thickness of a coating layer of a rear catalyst carried by the carrier on the outlet side of the exhaust gas of the casing is set to be larger than a thickness of a coating layer of a front catalyst carried by the carrier on the inlet side of the exhaust gas. An opening area of the carrier carrying the catalyst on the outlet side of the exhaust gas is set to be smaller than an opening area of a carrier carrying the catalyst on the inlet side of the exhaust gas.

### BRIEF DESCRIPTION OF THE DRAWINGS

The nature of this invention, as well as other objects and advantages thereof, will be explained in the following with reference to the accompanying drawings, in which like reference characters designate the same or similar parts throughout figures and wherein:

FIG. 1 is a total outline constitution view of an engine having an apparatus the same as an exhaust gas purifying apparatus according to an embodiment of the invention;

FIGS. 2A to 2C show a forestage carrier and a poststage carrier at inside of a catalyst converter used in the exhaust gas purifying apparatus of FIG. 1, FIG. 2A shows an outline perspective view, FIG. 2B shows an outline sectional view enlarging an essential portion of the forestage carrier, and FIG. 2C shows an outline sectional view enlarging an essential portion of the post stage carrier;

FIGS. 3A to 3C illustrate exhaust gas flowing characteristic views of the forestage carrier and the poststage carrier at inside of the catalyst converter used in the exhaust gas purifying apparatus of FIG. 1, FIG. 3A shows an outline side sectional view, FIG. 3B shows a schematic view of a coating layer of a front catalyst of a forestage carrier, and FIG. 3C shows a schematic view of a rear catalyst of the poststage carrier;

FIGS. 4A to 4C illustrate outline constitution views of a catalyst converter used in an exhaust gas purifying apparatus according to other embodiment of the invention, FIG. 4A shows an outline side sectional view, FIG. 4B shows a schematic view of a coating layer of a front catalyst of a forestage carrier, and FIG. 4C shows a schematic view of a rear catalyst of a poststage carrier;

FIGS. 5A to 5C illustrate outline constitution views of a catalyst converter used in an exhaust gas purifying apparatus according to other embodiment of the invention, FIG. 5A shows an outline side sectional view, FIG. 5B shows a schematic view of a coating layer of a front catalyst of a forestage carrier, and FIG. 5C shows a schematic view of a rear catalyst of a poststage carrier;

FIGS. 6A to 6C illustrate outline constitution views of a catalyst converter used in an exhaust gas purifying apparatus according to other embodiment of the invention, FIG. 6A shows an outline side sectional view, FIG. 6B shows an outline sectional view enlarging an essential portion of a forestage carrier, and FIG. 6C shows an outline sectional view enlarging an essential portion of a poststage carrier; and

FIGS. 7A to 7C illustrate outline views of an exhaust gas purifying apparatus according to other embodiment of the invention, FIG. 7A shows a first embodiment of a three stages carrier, FIG. 7B shows a second embodiment of the three stages carrier, and FIG. 7C shows a third embodiment of the three stages carrier.

### DETAILED DESCRIPTION OF THE PREFERRED EMBODIMENTS

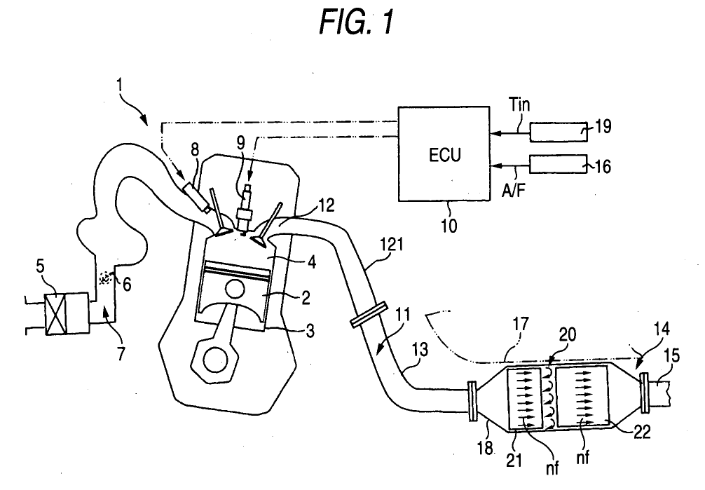

FIG. 1 shows an exhaust gas purifying apparatus according to the embodiment of the invention and an internal combustion engine mounted with the apparatus. The internal combustion engine is a 4 cycle multicylinders gasoline engine (hereinafter, simply described as engine 1) and inside of a main body of the engine 1 is arranged with cylinders 3 having pistons 2 by a number of the cylinders (only one thereof is shown in the drawing). In driving the engine 1, a combustion chamber 4 at inside of the cylinder 3 sucks intake air from an intake path 7 by way of an air cleaner 5, a throttle valve 6, fuel is injected by driving an electromagnetic type fuel injection valve 8 at a predetermined fuel injection timing by an engine control apparatus (ECU) 10, further, an ignition processing is carried out by pertinently driving the ignition plug 9. Thereby, the engine 1 carries out driving in a mode of operating the 4 cycle internal combustion engine by operating to generate an output by combusting a mixture gas and exhausting an exhaust gas to an exhaust path 11.

Here, an exhaust port 12 is formed from the engine main body at each cylinder substantially in a horizontal direction, and each exhaust port (only one thereof is shown in FIG. 1) is connected with an exhaust manifold 121 forming the exhaust path 11, an exhaust pipe 13 forming the exhaust path 11, a catalyst converter 14 attached to the exhaust pipe 13 and constituting an essential portion of the exhaust gas purifying apparatus, a downstream side exhaust pipe 15, and a muffler, not illustrated, in this order and is formed to be able to exhaust the exhaust gas to outside along the exhaust path 11. Further, the catalyst converter 14 is arranged below a floor 17 for ensuring an attaching space. Here, a temperature sensor 19 for detecting an intake temperature Tin is provided on the intake path 7, further, an air fuel ratio sensor 16 for detecting an air fuel ratio A/F is provided at the exhaust path 11.

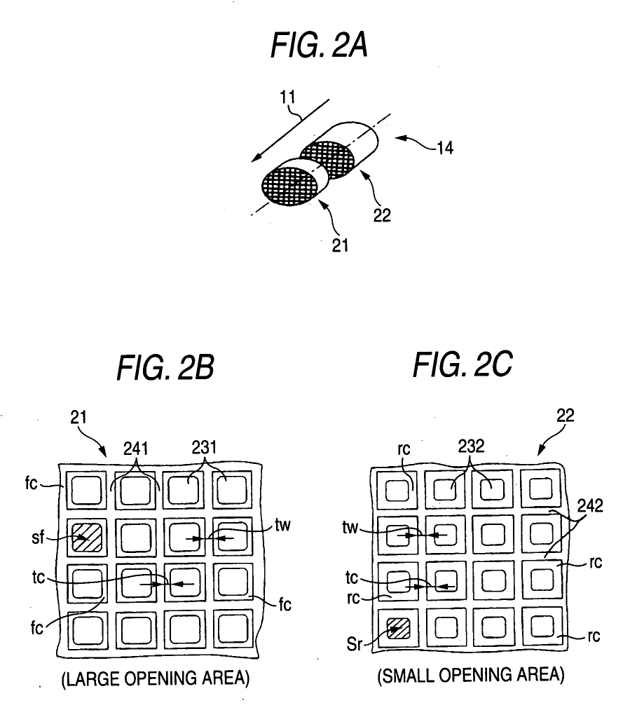

As shown by FIGS. 1 to 2C, the catalyst converter 14 constitutes a tandem catalyst system and is provided with a casing 18 in a cylindrical shape in a shape of enlarging an inner diameter thereof to be continuous to the exhaust pipe 13 and the downstream side exhaust pipe 15, a forestage carrier 21 and a poststage carrier 22 arranged at inside of the casing 18 from an exhaust gas inlet side (left side of FIG. 1) to an outlet side (right side of FIG. 1) thereof respectively by way of a gap portion 20.

Here, a thickness Lf in an exhaust gas flow path direction of the forestage carrier 21 is formed to be smaller than a thickness Lr in the exhaust gas flow path direction of the poststage carrier 22 (a capacity of the forestage carrier 21 is formed to be smaller than that of the poststage carrier 22), a heat capacity of the forestage carrier 21 is formed to be sufficiently smaller than a heat capacity of the poststage carrier 22 even when amounts of carrying front, rear catalyst 21a, 22a carried thereby into consideration, thereby, early activation of the front catalyst 21a is achieved.

As shown by FIGS. 2A to 2C, the forestage carrier 21 on the exhaust gas inlet side and the poststage carrier 22 on the exhaust gas outlet side respectively constitute a honeycomb structure and include a number of through holes 231, 232 at which the exhaust gas flows, and carrier walls 241, 242 (hereinafter, described by notation 24 when the front and rear carrier walls are commonly indicated) for partitioning the respective through holes 23 (hereinafter, the notation is described when the front and the rear through holes are commonly indicated).

Here, both of the forestage carrier 21 shown in FIG. 2B and the poststage carrier 22 shown in FIG. 2C are formed by a cell density of 600 cpsi (600 cells per square inch). Further, both of the carrier walls 241, 242 of the forestage carrier 21 and the poststage carrier 22 are formed by cogelite by forming thicknesses tw thereof by 4 mil (substantially: 4×25 μm).

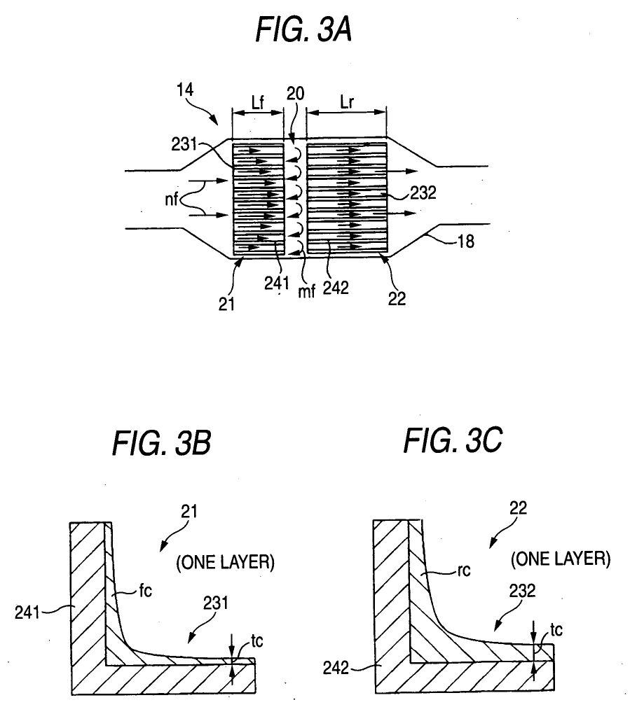

Further, as shown by FIGS. 3A to 3C, the carrier wall 241 of the forestage carrier 21 and the carrier wall 242 of the poststage carrier 22 respectively carry single layers of the front catalyst (representatively shown by a front coating layer fc) and the rear catalyst (representatively shown by a rear coating layer rc) and a wash coating capacity of the rear catalyst is formed to be larger than that of the front catalyst. As an example, assuming that kinds of the catalysts (wash coating densities) of the forestage carrier 21 and the poststage carrier 22 are the same, the carrier wall 241 of the forestage carrier 21 carries the front catalyst of the wash coating capacity of 100 through 150 g/L and the carrier wall 221 of the poststage carrier 22 carries the rear catalyst of the wash coating capacity of 200 through 250 g/L.

Here, the forestage carrier 21 ensures a comparatively wide opening area Sf (refer to FIG. 2B) restricted by the carrier wall 241 having the thickness of tw and the front catalyst of the comparatively thin front coating layer fc. The poststage carrier 22 ensures a comparatively narrow opening area Sr (refer to FIG. 2C) restricted by the carrier wall 241 having the thickness of tw and the post catalyst of the comparatively thick rear coating layer rc.

Here, the front and rear catalysts 21a, 22a are constituted by three way catalysts, and the front catalyst 21a constituting the front coating layer fc for mainly carrying out a reduction in HC in cold starting since a temperature thereof is elevated precedingly by receiving heat from the exhaust gas basically prior to the rear catalyst 22a is formed by being mainly constituted by paradium Pd which is comparatively inexpensive as a noble metal and excellent in reduction in HC in cold starting and added with a predetermined additive agent OSC. The rear catalyst 22a constituting the rear coating layer rc for mainly carrying out a reduction in NOx in a warm mode is formed by Pt (platinum) as a noble metal excellent in balance of a purifying characteristic starting from purification of NOx and added with the predetermined additive agent OSC. The front and rear respective three way catalysts are provided with a three way function of oxidizing CO, HC and deoxidizing NOx in the exhaust gas to purify under an atmosphere of a theoretical air fuel ratio and a rich atmosphere.

Further, in place of the noble metals, as a noble metal of the front catalyst 21a constituting the front coating layer fc in this case, there may be adopted rhodium which is excellent in low temperature activation although the price of the noble metal is generally high added with paradium (paradium+rhodium), and adopted a noble metal whose major component is rhodium excellent in the function of purifying NOx as the noble metal of the rear catalyst 22a constituting the rear coating layer rc (or platinum+rhodium) and a similar three way catalyst function is achieved also in this case.

The exhaust gas purifying apparatus having such a constitution achieves the exhaust gas purifying function in driving the engine. First, ECU10 of the engine 1 drives the engine 1 by an instructed operating mode based on respective operating information by driving the fuel injection nozzle 6 by an injection control function (not illustrated) in accordance with engine operating information of the intake temperature Tin and the air fuel ratio A/F and driving to ignite the ignition plug 9 by controlling a timing of igniting the ignition plug 9 by an adding timing control function portion (not illustrated). In cooperation with the operation of the engine, as shown by FIG. 1, FIG. 3A, the exhaust gas flows in the exhaust path 11 at inside of the exhaust pipe 13, the exhaust gas flows to the exhaust pipe 13, the casing 18, and flows into the through hole 231 of the forestage catalyst 21a at inside of the casing 18. In this case, as shown by FIG. 3A, the efficiency of purifying the exhaust gas in passing the carrier 21 is deviated by a factor of producing a difference in a speed distribution in a diameter direction by enlarging a pipe diameter at the inlet portion of the casing 18 and dispersing the purifying characteristic of the catalyst by making a temperature at a center portion of the casing higher than that at a peripheral edge portion. Further, the forestage carrier 21 is formed such that a heat capacity is sufficiently smaller than that of the poststage carrier 22, a temperature thereof is elevated at a comparatively early stage to be able to achieve early activation and to be able to promote the purifying efficiency.

Further, as shown by FIG. 2B, by forming the opening area Sr of the poststage carrier 22 comparatively narrower than the opening area Sf of the forestage carrier 21, a flow in a forward direction nf from the forestage carrier 21 to the poststage carrier 22 can be restrained and a turbulent flow mf (refer to FIG. 3A) can be promoted to generate. Thereby, agitation (mixing) of an unreacted substance of the exhaust gas is promoted, the exhaust gas mixed with the unreacted substance to be substantially made to be uniform becomes the forward flow nf without a deviation in the casing diameter direction to flow to the poststage carrier 22 and at the poststage catalyst 22a, the purifying reaction is uniformly promoted.

That is, mixing of the exhaust gas is brought about by a turbulence produced when the exhaust gas to the poststage carrier 22 from the gap portion between the forestage carrier 21 and the poststage carrier 22 flows to the poststage carrier 22, here, the opening area Sr of the poststage carrier 22 is formed to be smaller than the opening area Sf of the forestage carrier 21 and therefore, the exhaust gas coming out from the forestage carrier 21 cannot flow smoothly to the poststage carrier 22 and is impacted to the carrier wall face to restrict the flow. Thereby, the turbulence is strongly brought about at a gap portion and mixing is carried out further actively. The mixing makes the concentration and the temperature of the forestage catalyst outlet gas (poststage catalyst inlet gas) uniform to promote the reaction at the poststage catalyst.

Normally, a temperature of an outer contour side of the catalyst is lower than a center portion thereof owing to cooling from outside. The purifying performance strongly depends on the temperature and therefore, a concentration of an unpurified component (HC, NOx, CO) of a gas passing the outer contour side of the catalyst is higher than that of the center portion. Therefore, by mixing the gas after passing the forestage catalyst at a gap portion between the forestage catalyst and the poststage catalyst, a probability of passing the high concentration unpurified component passing the outer contour portion of the forestage catalyst to the outer contour side of the poststage catalyst as it is is reduced and on the other hand, a probability thereof for passing the catalyst center portion of the poststage catalyst is increased. The temperature is high and the purifying efficiency is also high at the catalyst center portion and therefore, the high concentration unpurified component passing the outer contour portion of the forestage catalyst is excellently purified at the catalyst center of the poststage catalyst and the purifying performance of the total of the catalyst is promoted.

In this way, according to the exhaust gas purifying apparatus of FIG. 1 to FIG. 3C, by equalizing the cell densities of the forestage carrier 21 and the poststage carrier 22 and the thicknesses tw of the carrier walls 241, 242 and making a coating layer thickness tc of the front catalyst 21a carried by the forestage carrier 21 comparatively small, the opening area Sf of the forestage carrier 21 is formed to be larger than the opening area Sr of the poststage carrier 22.

Therefore, since the opening area Sr of the poststage carrier 22 is comparatively small, the turbulent flow mf of the exhaust gas can be promoted to be brought about at the gap portion 20, mixing of the exhaust gas is promoted, the purifying reaction of the poststage carrier 22 is not deviated in the casing section direction and made to be uniform and promotes the exhaust gas purifying performance. Further, since the coating layer thickness tc of the coating layer fc of the forestage carrier 21 is comparatively thin, a gas diffusing performance can be promoted and the exhaust gas purifying performance can be promoted by thinning the coating layer fc of the front stage having a significant influence on the exhaust gas purifying performance.

Further, with regard to the rear catalyst 22a, since the coating layer thickness tc of the coating layer rc is comparatively thick, a performance of dispersing the noble metal is improved. That is, a density of the noble metal per unit wash coating amount is reduced and a distance between particles of noble metal is increased and therefore, sintering (coagulation) of the noble metal after thermal resistance is difficult to be brought about and durability is ensured. Further, the length Lr of the poststage carrier 22 is formed to be comparatively long, thereby, the comparatively large amount of the rear catalyst constituting the rear coating layer rc is carried and durability of the exhaust gas purifying apparatus can sufficiently be ensured.

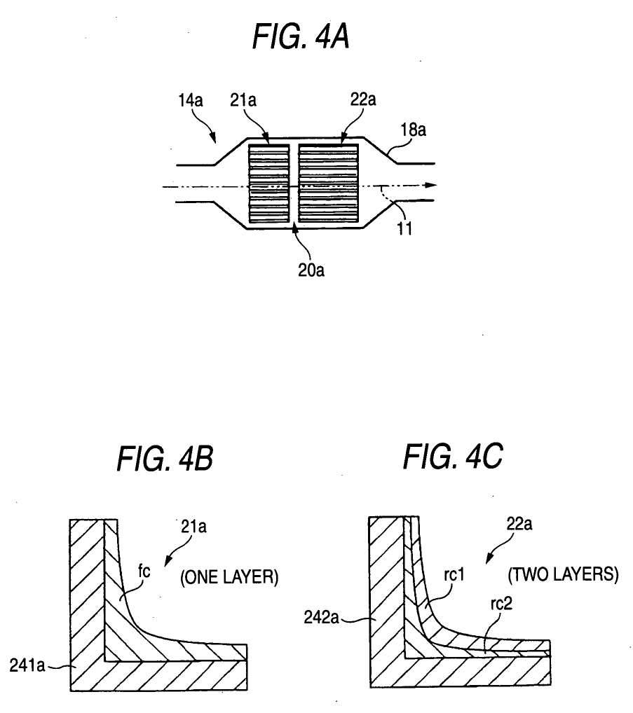

FIGS. 4A to 4C show an exhaust gas purifying apparatus according to other embodiment. According to the exhaust gas purifying apparatus, in comparison with the exhaust gas purifying apparatus shown in FIGS. 1 to 3C, by adopting the same constitution other than a difference in portions of constitutions of the forestage and the poststage carriers 21a, 22a at inside of the casing 18a, a duplicating explanation thereof will be omitted here, the same members are attached with the same notations and attached with a notation a and the explanation will be simplified. A casing 18a of a catalyst converter 14a of the exhaust gas purifying apparatus shown in FIGS. 4A to 4C is arranged with a forestage carrier 21a, a poststage carrier 22a the same as the forestage carrier 21, the poststage carrier 22 of FIG. 1 by way of a gap portion 20a the same as the gap portion 20 of FIG. 1.

The forestage carrier 21a carries a single layer of the front catalyst (representatively shown by the front coating layer fc) similar to the forestage carrier 21 of FIG. 1 and the poststage carrier 22a carries two upper and lower layers of the rear catalyst (representatively shown by rear coating layers rc1, rc2). Here, assuming that kinds of catalysts (wash coating densities) of the forestage carrier 21a and the poststage carrier 22a stay the same, the front catalyst constituting the front coating layer fc of the wash coating capacity of 100 g/L is carried by a carrier wall 241a of the forestage carrier 21a and the two upper and lower layers of the rear catalyst constituting the rear coating layers rc1, rc2 respectively having the wash coating capacity of 100 g/L are carried by a carrier wall 221a of the poststage carrier 22a. Here, the rear catalyst of the poststage carrier 22a is carried by a layer thickness twice as much as that of the forestage carrier 21a to ensure durability of the catalyst of the exhaust gas purifying apparatus in view of a performance thereof.

Also in this case, the opening area Sf of the forestage carrier 21a is ensured to be larger than the opening area Sr of the poststage carrier 22a, thereby, the turbulent flow mf of the exhaust gas of a gap portion 20a (refer to FIG. 3A) can be promoted to be brought about, mixing of the exhaust gas is promoted, the purifying reaction of the poststage carrier 22 is made to be uniform without a deviation in a casing section direction and the exhaust gas purifying performance can be promoted.

The front and the rear catalysts 21a, 22a in this case are constituted by three way catalysts, the noble metal at the front coating layer fc is formed by being mainly constituted by paradium Pd and added with the predetermined additive agent OSC. According to the two upper and lower layers of the rear coating layers rc1, rc2, the upper layer of the rear coating layer rc1 brought into contact with the exhaust gas first is formed by being mainly constituted by rhodium Rd the most excellent in the purifying performance in the noble metals as the noble metal and the lower layer of the rear coating layer rc2 is formed by being mainly constituted by platinum Pt as the noble metal and added with the predetermined additive agents OSC respectively at separate layers.

Also in this case, similar to the exhaust gas purifying apparatus of FIG. 1, the front and rear respective three way catalysts achieve the three way function of oxidizing CO, HC and deoxidizing NOx in the exhaust gas under an atmosphere at a vicinity of the theoretical air fuel ratio to purify to purify the exhaust gas to thereby achieve a similar effect. Particularly, by arranging the noble metals of the post catalyst constituting the rear coating layers rc1, rc2 at the layers respectively separate from each other, there can be excluded a deterioration in the catalyst by bonding metals of rhodium Rd and platinum Pt to each other ageingly as in a case of fixing a plurality of noble metals in a single layer, durability can be promoted, at the same time, by optimally arranging the noble metals and the additive agent to the respective layers, the catalyst performance can be promoted. Further, low cost formation can be achieved by reducing an amount of using rhodium Rd generally having the high price of the noble metal.

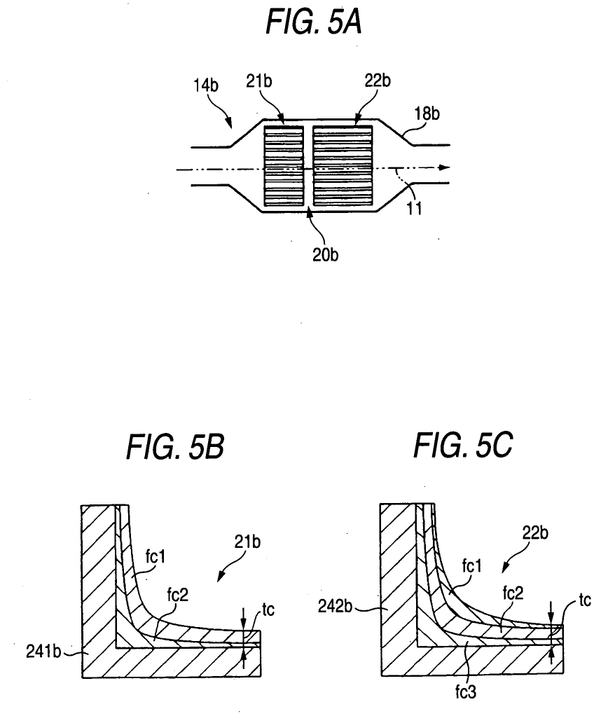

FIGS. 5A to 5C show an exhaust gas purifying apparatus according to other embodiment. In comparison with the exhaust gas purifying apparatus shown in FIGS. 1, 3A to 3C, the exhaust gas purifying apparatus adopts the same constitution other than that numbers of layers of the front and the rear catalysts carried by the forestage carrier and the poststage carrier 21b, 22b in a casing 18b differ therefrom, a duplicating explanation thereof will be omitted here, the same members are attached with the same notations and a notation b and an explanation thereof will be simplified.

The casing 18b of a catalyst converter 14b of the exhaust gas purifying apparatus shown in FIGS. 5A to 5C are arranged with a forestage carrier 21b, a poststage carrier 22b and a gap portion 20b similar to the catalyst converter 14 of FIG. 1. Two upper and lower layers of the front catalyst (representatively shown by front coating layers fc1, fc2) is carried by a carrier wall 241b of the forestage carrier 21b. Three upper and a middle and a lower layers of the rear catalyst (representatively shown by rear coating layers rc1, rc2, rc3) are carried by a carrier wall 242b of the poststage carrier 22b.

Also in this case, the opening area Sf of the forestage carrier 21b is ensured to be larger than the opening area Sr of the poststage carrier 22b. Thereby, the turbulent flow mf (refer to FIG. 3A) of the exhaust gas can be promoted to be brought about at the gap portion 20b, mixing of the exhaust gas is promoted, the purifying reaction at the poststage carrier 22b is made to be uniform without a deviation in the casing section direction and exhaust gas purifying performance can be promoted.

The front and the rear catalysts in this case are also constituted by three way catalysts, the noble metal of the upper front coating layer fc1 of the front catalyst brought into contact with the exhaust gas first is formed by being constituted mainly by rhodium Rh the most excellent in low temperature activity and the noble metal of the lower front coating layer fc2 is formed by being mainly constituted by paradium Pd by being respectively added with the predetermined additive agent OSC. The noble metal of the upper rear coating layer rc1 of the rear catalyst is formed by being mainly constituted by paradium Pd, the middle rear coating layer rc2 is formed by being mainly constituted by rhodium Rd, and the lower rear coating layer rc3 is formed by being mainly constituted by platinum Pt by being respectively added with the predetermined additive agent OSC.

Also in this case, similar to the exhaust gas purifying apparatus of FIG. 1, the front and rear respective three way catalysts achieve the three way performance of oxidizing Co, HC and deoxidizing NOx in the exhaust gas under the atmosphere of the theoretical air fuel ratio and the rich atmosphere to purify the exhaust gas to thereby achieve the similar effect. Particularly, by arranging the respective coating layers fc1, fc2 of the front catalyst and the respective coating layers rc1, rc2, rc3 of the post catalyst respectively at separate layers, there can be excluded a deterioration in the catalyst by bonding metals of noble metals to each other ageingly brought about when the plurality of noble metals are mixed respectively in single layers in the front and the rear respective catalysts, durability can be promoted, the layer thicknesses tc can easily be ensured in both the front and the rear catalysts and durability can be promoted.

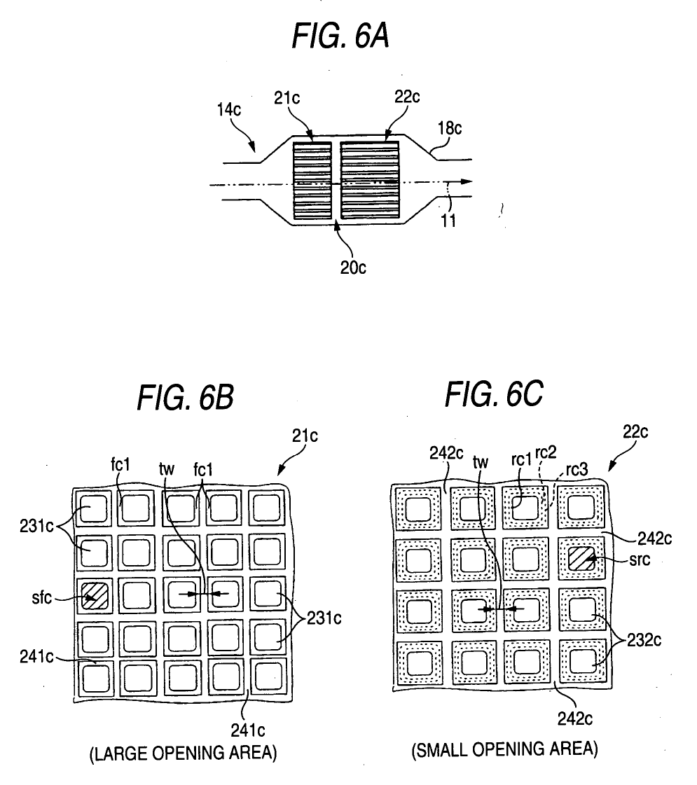

FIGS. 6A to 6C show an exhaust gas purifying apparatus as other embodiment. Although the exhaust gas purifying apparatus adopts a number of constitutions similar to those of FIGS. 5A to 5C, the exhaust gas purifying apparatus differs therefrom particularly in that the front catalyst of a forestage carrier 21c is constituted by a single layer of a front coating layer fc1 and the noble metals is formed by being mainly constituted by paradium Pd, and that in adopting a constitution in which the opening area Src of a poststage carrier 22c is formed to be smaller than the opening area Sfc of the forestage carrier 21c, particularly, a cell density of the forestage carrier 21c is set to be larger than that of the poststage carrier 22c.

According to the exhaust gas purifying apparatus of FIGS. 6A to 6C, the forestage carrier 21c is formed by a cell density of 900 cpsi (900 cells per square inch) and the poststage carrier 22c is formed by a cell density of 600 cpsi (600 cells per square inch). Further, the thickness tw of a carrier wall 241c of the forestage carrier 21c is constituted by 2.5 mil (substantially: 2.5×25 μm), the thickness tw of a carrier wall 242c of the poststage carrier 22c is constituted by 4 mil (substantially: 4×25 μm) and both thereof are formed by cogelite.

Also in this case, the opening area Src of the poststage carrier 22c is set to be maintained to be smaller than the opening area Sfc of the forestage carrier 21c. Therefore, a turbulent flow mf of the exhaust gas can be promoted to be brought about at the gap portion 20b, mixing of the exhaust gas is promoted, the purifying reaction at the poststage carrier 22b is made to be uniform without deviation in the casing section direction and the exhaust gas purifying performance can be promoted.

Also in this case, the front and the rear catalysts are constituted by three way catalysts, the noble metal of the single front coating layer fc1 of the front catalyst is formed by being mainly constituted by paradium Pd and added with the predetermined additive agent OSC. According to the rear catalyst, similar to the rear catalyst of FIGS. 5A to 5C, the upper rear coating layer rc1 is formed by being mainly constituted by paradium Pd, the middle rear coating layer rc2 is formed by being mainly constituted by rhodium Rd, the lower rear coating layer rc3 is formed by being mainly constituted by platinum Pt, respectively, and added with the predetermined additive agent OSC respectively. Also in this case, similar to the exhaust gas purifying apparatus of FIGS. 5A to 5C, the front and rear respective three way catalysts achieve the three way function of oxidizing CO, HC and deoxidizing NOx in the exhaust gas under the atmosphere at a vicinity of the theoretical air fuel ratio to purify the exhaust gas to thereby achieve the similar effect.

Particularly, the coating layer fc1 of the front catalyst is formed in a comparatively thin wall and therefore, the gas diffusing performance at the coating layer is promoted and the exhaust gas purifying performance of the front catalyst can be promoted. Further, after setting to maintain the opening area Src of the poststage carrier 22c to be smaller than the opening area Sfc of the forestage carrier 21c, the cell density of the forestage carrier 21c is formed to be large and therefore, a high specific surface area can be maintained by the front catalyst of the forestage carrier 21c and the exhaust gas purifying performance can be promoted also in this respect.

Although in the above-described, according to the exhaust gas purifying apparatus of the respective embodiments, the respective front catalysts and the respective rear catalysts are constituted by the three way catalysts, in place thereof, the front catalyst may be constituted by an NOx catalyst and the poststage catalyst may be constituted by the three way catalyst, also in the case, operation and effect substantially similar to those of the exhaust gas purifying apparatus of FIG. 1 are achieved. Further, the forestage catalyst may be constituted by the three way catalyst and the poststage catalyst may be constituted by the NOx catalyst. Particularly when an NOx trap catalyst is applied as the NOx catalyst, the NOx trap catalyst tends to increase a thickness or a number of coating layers by an amount of a trap agent and therefore, the NOx trap catalyst is suitable for the poststage catalyst of the invention. Similarly, the forestage catalyst may be constituted by the three way catalyst and the poststage catalyst may be constituted by an HC trap catalyst and also in this case, the HC trap catalyst tends increase a thickness or a number of coating layers by amount of the trap agent and therefore, the HC trap catalyst is suitable for the poststage catalyst of the invention.

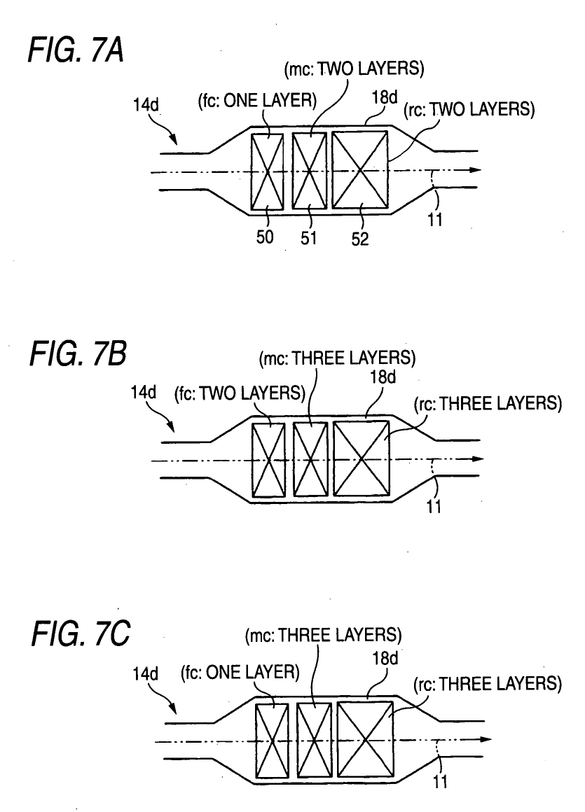

Although in the above-described, the casing 18 of the catalyst converter 14 of each of the exhaust gas purifying apparatus is arranged with the forestage carrier 21 and the poststage carrier 22 at the two front and rear stages along the direction of the exhaust path, in place thereof, as shown by FIGS. 7A to 7C, inside of a casing 18d of a catalyst converter 14d may be arranged in three stages with a forestage carrier 50, a middlestage carrier 51, a poststage carrier 52, thereafter, an opening area of the middlestage carrier 51 is made to be narrower than an opening area of the forestage carrier 50, and the opening area of the middlestage carrier 51 may be formed to be equivalent to or narrower than an opening area of the poststage carrier 52.

In this case, in FIG. 7A, a front catalyst, middle catalyst, a rear catalyst of the forestage carrier 50, the middlestage carrier 51, the poststage carrier 52 are respectively formed by one layer, two layers, two layers, in FIG. 7B, the front catalyst, the middle catalyst, the rear catalyst of the forestage carrier 50, the middlestage carrier 51, the poststage carrier 52 are respectively formed by two layers, three layers, three layers, in FIG. 7C, the front catalyst, the middle catalyst, the rear catalyst of the forestage carrier 50, the middlestage carrier 51, the poststage carrier 52 are respectively formed by one layer, three layers, three layers.

Also in the case, early activation can be achieved by pertinently selecting the noble metals of the respective coating layers fc, mc, rc and reducing the heat capacity of the forestage carrier 50, the exhaust gas purifying performance of the front catalyst can be promoted by promoting the gas diffusing performance by constituting the coating layer fc by comparatively thin wall, the durability can be ensured by forming the middle catalyst, the rear catalyst of the middlestage carrier 51, the poststage carrier 52 respectively by pluralities of layers and low cost formation can be achieved by pertinently selecting to use the noble metals.

What is claimed is:

1. An exhaust gas purifying apparatus, comprising:
a casing provided at an exhaust path of an internal combustion engine; and
a plurality of carriers arranged in the casing from an inlet side of an exhaust gas to an outlet side thereof and connected to each other through gap portions, each of the carriers including through holes in which the exhaust gas flows and a carrier wall to partition the though holes and to carry a catalyst to purify the exhaust gas, wherein
a thickness of a coating layer of a rear catalyst carried by the carrier on the outlet side of the exhaust gas of the casing is set to be larger than a thickness of a coating layer of a front catalyst carried by the carrier on the inlet side of the exhaust gas, and
an opening area of the carrier carrying the catalyst on the outlet side of the exhaust gas is set to be smaller than an opening area of a carrier carrying the catalyst on the inlet side of the exhaust gas.

2. The exhaust gas purifying apparatus according to claim 1, wherein
a length in a direction of an exhaust gas flow path of the carrier on the inlet side of the exhaust gas is set to be shorter than a length in the direction of the exhaust gas flow path of the carrier on the outlet side of the exhaust gas.

3. The exhaust gas purifying apparatus according to claim 1, wherein
a number of the coating layer of the rear catalyst carried by the carrier on the outlet side of the exhaust gas is set to be larger than a number of the coating layer of the front catalyst carried by the carrier on the inlet side of the exhaust gas.

4. The exhaust gas purifying apparatus according to claim 1, wherein
a cell density corresponding to a number of the through hole of the carrier on the inlet side of the exhaust gas is set to be larger than a cell density corresponding to a number of the through hole of the carrier on the outlet side of the exhaust gas.

5. The exhaust gas purifying apparatus according to claim 1, wherein
the front catalyst carried by the carrier on the inlet side of the exhaust gas mainly includes paradium or rhodium, and
the rear catalyst carried by the carrier on the outlet side of the exhaust gas mainly includes platinum or rhodium.

6. The exhaust gas purifying apparatus according to claim 1, wherein
when at least one of the coating layer of the front catalyst carried by the carrier on the inlet side of the exhaust gas and the coating layer of the rear catalyst carried by the carrier on the outlet side thereof includes upper and lower layers, the upper layer is formed by a catalyst mainly includes rhodium and the lower layer is formed by a catalyst mainly includes platinum.
